(19) United States
(12) Patent Application Publication
(10) Pub. No.: US 2026/0314673 A1
(43) Pub. Date: Oct. 15, 2026

(54) HEATER AND AEROSOL GENERATING DEVICE

(71) Applicant: SHENZHEN FIRST UNION TECHNOLOGY CO., LTD., Shenzhen, Guangdong (CN)

(72) Inventors: Zhiming LU, Shenzhen, Guangdong (CN); Ruilong HU, Shenzhen, Guangdong (CN); Zhongli XU, Shenzhen, Guangdong (CN); Yonghai LI, Shenzhen, Guangdong (CN)

(73) Assignee: SHENZHEN FIRST UNION TECHNOLOGY CO., LTD., Shenzhen, Guangdong (CN)

(21) Appl. No.: 19/485,085

(22) PCT Filed: May 20, 2024
(86) PCT No.: PCT/CN2024/094240

§ 371 Date: Nov. 17, 2025

(30) Foreign Application Priority Data
May 25, 2023 (CN) 202321305473.3

(51) Int. Cl. A24F 40/46; A24F 40/20

(52) U.S. Cl. CPC A24F 40/46; A24F 40/20

(57) ABSTRACT

A heater and an aerosol generating device. The heater includes a base body and a conductive electrode. The base body has a proximal end and a distal end opposite to each other. A material of the base body includes a conductive ceramic. The base body is configured to heat an aerosol-forming substrate to generate an aerosol, and incudes a first portion close to the proximal end or the distal end and a second portion located between the proximal end and the distal end. A thickness of the first portion is greater than a thickness of the second portion. The conductive electrode is arranged on an end surface of the proximal end and/or the distal end. Thicknesses of two ends of the base body are greater than a thickness of a middle portion of the base body.

### CROSS-REFERENCE TO RELATED APPLICATIONS

This application claims priority to Chinese Patent Application No. 202321305473.3, filed with the China National Intellectual Property Administration on May 25, 2023 and entitled “HEATER AND AEROSOL GENERATING DEVICE”, which is incorporated herein by reference in its entirety.

### TECHNICAL FIELD

This application relates to the field of electronic atomization technologies, and in particular, to a heater and an aerosol generating device.

### BACKGROUND

In an existing aerosol generating device, a conductive coating is mainly coated on an outer side surface of a conductive ceramic base body. After being energized, the conductive ceramic base body may heat an aerosol-forming substrate to generate an inhalable aerosol.

The problems existing in the aerosol generating device are that part of the conductive ceramic base body does not generate heat, and the conductive ceramic base body has large heat capacity and low heating efficiency.

### SUMMARY

An aspect of this application provides a heater, including: a base body, having a proximal end and a distal end opposite to each other, where a material of the base body includes a conductive ceramic, the base body is configured to heat an aerosol-forming substrate to generate an aerosol, the base body includes a first portion close to the proximal end or the distal end, and a second portion located between the proximal end and the distal end, a thickness size of the first portion is greater than a thickness size of the second portion; and a conductive electrode, arranged on an end surface of the proximal end and/or the distal end.

In an example, the base body is configured to generate an infrared ray for radiative heating of the aerosol-forming substrate.

In an example, the base body is configured to perform heating around at least one portion of the aerosol-forming substrate.

In an example, the thickness size of the second portion ranges from 0.5 mm to 0.2 mm.

In an example, the base body is configured as a tubular structure, and an inner diameter of the base body ranges from 6 mm to 15 mm or 5 mm to 5.9 mm.

In an example, the conductive electrode is arranged on an entire end surface of the proximal end and/or the distal end.

In an example, the base body is configured as a tubular structure, and the conductive electrode is configured as a planar electrode in a circular ring shape.

In an example, a difference between the thickness size of the first portion and the thickness size of the second portion ranges from 0.3 mm to 1.8 mm.

In an example, a thickness of the conductive electrode ranges from 0.05 μm to 50 μm.

Another aspect of this application further provides an aerosol generating device, including a housing; a heater, arranged in the housing; and a battery core, configured to provide electric power.

In an example, the aerosol generating device further includes an electrode connector. The electrode connector includes a body that keeps in contact with a conductive electrode, and a pin extending from the body toward a direction away from the base body.

In an example, the electrode connector further includes a positioning portion extending from the body toward the direction away from the base body.

According to the heater and the aerosol generating device provided in this application, the conductive electrode is arranged on the end surface of the proximal end and/or the distal end of the base body, and thickness sizes of two ends of the base body are greater than a thickness size of a middle portion of the base body, so that the conductive electrode is conveniently arranged on end surfaces of the two ends of the base body. In addition, a thickness of the middle portion of the base body is relatively smaller, thereby further reducing heat capacity of the conductive ceramic base body, and improving heating efficiency of the heater.

### BRIEF DESCRIPTION OF THE DRAWINGS

One or more embodiments are exemplarily described with reference to the corresponding figures in the accompanying drawings, and the descriptions are not to be construed as a limitation on the embodiments. Elements in the accompanying drawings that have same reference numerals are represented as similar elements, and unless otherwise particularly stated, the figures in the accompanying drawings are not drawn to scale.

FIG. 1 is a schematic diagram of an aerosol generating device according to an implementation of this application.

FIG. 2 is a schematic exploded view of an aerosol generating device according to an implementation of this application.

FIG. 3 is a schematic diagram of a heating assembly according to an implementation of this application.

FIG. 4 is a schematic cross-sectional view of a heating assembly according to an implementation of this application.

FIG. 5 is a schematic exploded view of a heating assembly according to an implementation of this application.

FIG. 6 is a schematic diagram of a heater according to an implementation of this application.

FIG. 7 is a schematic cross-sectional view of a heater according to an implementation of this application.

FIG. 8 is a schematic diagram of an electrode connector according to an implementation of this application.

FIG. 9 is a schematic diagram of an upper end cap according to an implementation of this application.

FIG. 10 is a schematic diagram of an upper end cap from another perspective according to an implementation of this application.

FIG. 11 is a schematic diagram of a first seal member according to an implementation of this application.

FIG. 12 is a schematic diagram of a first seal member from another perspective according to an implementation of this application.

FIG. 13 is a schematic diagram of a second seal member according to an implementation of this application.

FIG. 14 is a schematic diagram of a second seal member from another perspective according to an implementation of this application.

FIG. 15 is a schematic diagram of a lower end cap according to an implementation of this application.

FIG. 16 is a schematic diagram of a lower end cap from another perspective according to an implementation of this application.

### DETAILED DESCRIPTION

To facilitate understanding of this application, this application is described in more detail below with reference to accompanying drawings and specific implementations. It should be noted that when an element is described to be “fixed to” another element, the element may be directly fixed to the another element, or one or more intermediate elements may exist therebetween. When one element is described to be “connected to” another element, the element may be directly connected to the another element, or one or more intermediate elements may exist therebetween. Terms “upper”, “lower”, “left”, “right”, “inner”, “outer”, and similar expressions used in the specification are merely used for illustration.

Unless otherwise defined, meanings of all technical and scientific terms used in this specification are the same as those usually understood by a person skilled in the art of this application. The terms used in this specification of this application are merely intended to describe objectives of the specific implementations, and are not intended to limit this application. A term “and/or” used in this specification includes any or all combinations of one or more related listed items.

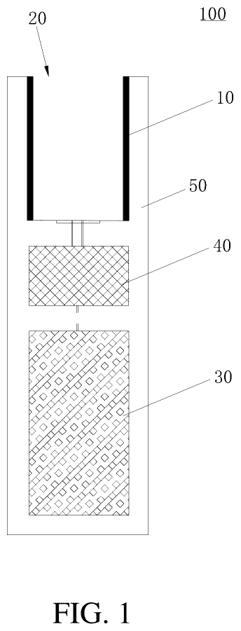

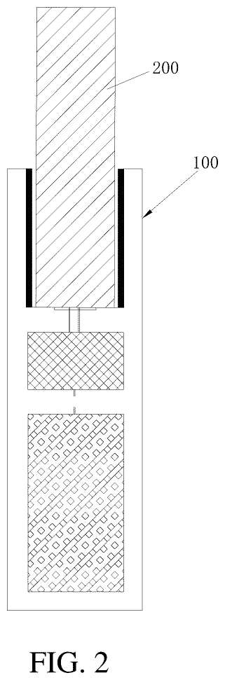

FIG. 1 and FIG. 2 show an aerosol generating device 100 according to an implementation of this application, including a heater 10, a chamber 20, battery core 30, a circuit 40, and a housing assembly 50. The heater 10, the chamber 20, the battery core 30, and the circuit 40 are all arranged in the housing assembly 50.

The heater 10 is configured to heat an aerosol-forming substrate to generate an inhalable aerosol.

The chamber 20 is configured to removably receive the aerosol-forming substrate.

In an example, the aerosol-forming substrate may conveniently be a part of an aerosol generating article 200. The aerosol-forming substrate is a substrate that can release a volatile compound that can form an aerosol. The volatile compound may be released by heating the aerosol-forming substrate. The aerosol-forming substrate may be a solid or a liquid, or components including the solid and the liquid. The aerosol-forming substrate may be mounted onto a carrier or a support through adsorption, coating, or impregnation, or in another manner.

The battery core 30 provides electric power for operating the aerosol generating device 100. For example, the battery core 30 may provide electric power for the heater 10 to perform heating. In addition, the battery core 30 may provide electric power required to operate another element provided in the aerosol generating device 100. The battery core 30 may be a rechargeable battery or a disposable battery.

The circuit 40 may control the overall operation of the aerosol generating device 100. The circuit 40 not only controls operations of the battery core 30 and the heater 10, but also controls an operation of another element in the aerosol generating device 100. For example, the circuit 40 obtains temperature information of the heater 10 sensed by a temperature sensor, and controls, based on the information, the electric power provided to the heater 10 by the battery core 30.

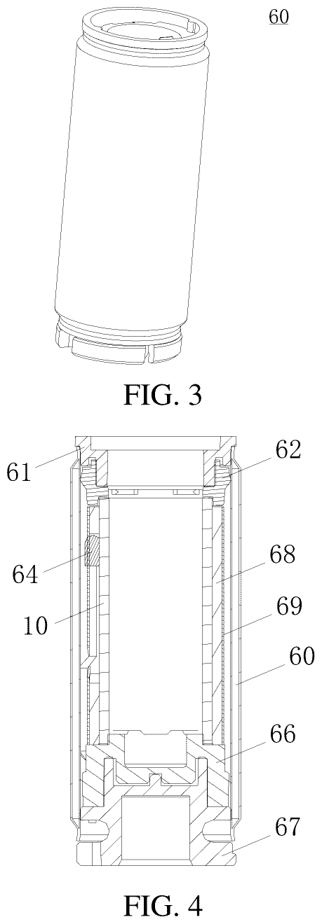

FIG. 3 to FIG. 5 show a heating assembly according to an implementation of this application.

A heating assembly 60 includes an upper end cap 61, a first seal member 62, a first electrode connector 63, a heater 10, a temperature sensor 64, a second electrode connector 65, a second seal member 66, a lower end cap 67, a heat insulation member 68, a keeping member 69, and an insulator 60.

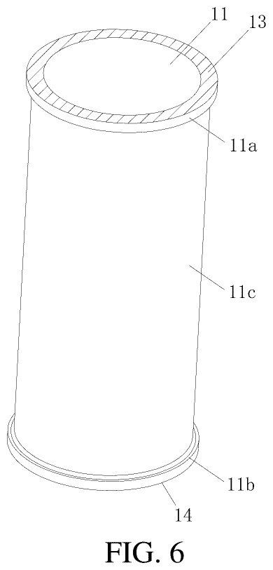

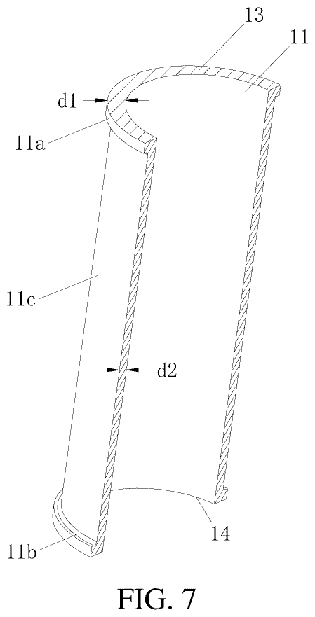

FIG. 6 and FIG. 7 show a heater according to an implementation of this application. The heater includes:
a base body 11, configured as a tubular structure, for example, in a shape of a cylinder, a prism, or another cylinder; and preferably in the shape of a cylinder. The base body 11 includes a proximal end, a distal end, and a side surface extending between the proximal end and the distal end. A hollow portion inside the base body 11 defines at least a portion of a chamber 20. The proximal end of the base body 11 is provided with a first opening in communication with the hollow portion inside the base body 11. At least a portion of an aerosol generating article 200 is removably received within the base body 11 through the first opening. When the aerosol generating article 200 is received within the base body 11, the heater 10 may perform heating by surrounding at least a portion of the aerosol generating article 200, which is referred to as circumferential heating or peripheral heating. The distal end of the base body 11 may also have a second opening in communication with the hollow portion inside the base body 11. Further, the second opening may be closed. In another example, the distal end of the base body 11 may not be provided with the second opening, which means that the distal end of the base body 11 is closed.

In an example, an inner diameter of the base body 11 ranges from 6 mm to 15 mm, or 7 mm to 15 mm, or 7 mm to 14 mm, or 7 mm to 12 mm, or 7 mm to 10 mm. An axial extension length of the base body 11 ranges from 15 mm to 30 mm, or 15 mm to 28 mm, or 15 mm to 25 mm, or 16 mm to 25 mm, or 18 mm to 25 mm, or 18 mm to 24 mm, or 18 mm to 22 mm.

In an example, the inner diameter of the base body 11 ranges from 5 mm to 5.9 mm, and in a specific example, may be 5.5 mm, 5.4 mm, or the like. The axial extension length of the base body 11 ranges from 30 mm to 60 mm, or 30 mm to 55 mm, or 30 mm to 50 mm, or 30 mm to 45 mm, or 30 mm to 40 mm. The base body 11 of the size is applicable to an elongated aerosol generating article.

A material of the base body 11 includes a conductive ceramic. The base body 11 of the conductive ceramic can receive electric power provided by a battery core 30 to generate heat and then generate an infrared ray of a certain wavelength, for example, far infrared rays ranging from 8 μm to 15 μm.

In an example, the base body 11 made of a conductive ceramic includes a main component and a doping component. The main component includes a first metal oxide. The doping component includes a second metal oxide. A valence of a metal in the first metal oxide is different from a valence of a metal in the second metal oxide. A mass percentage of the main component in the conductive ceramic is greater than 80% and less than or equal to 98%. Further, a mass percentage of the doping component in the conductive ceramic is greater than 0.5% and less than or equal to 19%. In the implementation, the metal in the second metal oxide obtains sufficient energy to enter a crystal lattice of the first metal oxide to play a donor doping role. To be specific, ion replacement is performed at a high temperature to increase a carrier concentration, to achieve ceramic conductivity.

In a specific example, the valence of the metal in the first metal oxide is less than the valence of the metal in the second metal oxide. Optionally, the valence of the metal in the second metal oxide is not less than 3.

The main component includes zinc oxide, and the doping component includes at least one of aluminum trioxide, zirconium dioxide, titanium dioxide, or niobium pentoxide. A mass percentage of zinc oxide to the conductive ceramic ranges from 94% to 98%. The doping component includes aluminum trioxide, and a mass percentage of aluminum trioxide to the conductive ceramic ranges from 0.5% to 5%.

Optionally, the conductive ceramic material includes zinc oxide with a mass percentage ranging from 94% to 98%, aluminum trioxide with a mass percentage ranging from 0.8% to 5%, titanium dioxide with a mass percentage ranging from 0% to 1%, and zirconium dioxide with a mass percentage ranging from 0% to 0.5%.

It may be understood that the foregoing base body 11 using conductive ceramic can reduce a maximum temperature hotspot area, eliminate the risk of fatigue cracking and increased fatigue resistance, and exhibit good consistency. Moreover, due to the high strength of the ceramic heating material and the smoothness caused by a microcrystalline structure, the side surface of the base body 11 is easy to clean and less prone to adhesion.

The base body 11 includes an upper portion 11a close to the proximal end, a lower portion 11b close to the distal end, and a middle portion 11c located between the proximal end and the distal end. A thickness size d1 of the upper portion 11a or the lower portion 11b is greater than a thickness size d2 of the middle portion 11c. To be specific, the thickness size of the proximal end and/or distal end of the base body 11 is greater than the thickness size of the middle portion 11c of the base body 11.

It may be seen from the figure that a difference in the thickness sizes of the upper portion 11a, the lower portion 11b, and the middle portion 11c causes the base body 11 to form a concave structure (two ends of the base body 11 protrude outward in a radial direction). A thickness of the middle portion of the base body is relatively small and may be reduced to less than 0.5 mm, thereby further reducing heat capacity of the base body 11 and improving heating efficiency of a heater. It may be understood that in another example, it is also feasible that two ends of the base body 11 protrude inward in the radial direction. In another example, it is also feasible that only the proximal end or the distal end of the base body 11 protrudes.

The thickness size d2 of the middle portion 11c ranges from 0.5 mm to 0.2 mm. In a specific example, the thickness size may be 0.4 mm, 0.3 mm, or the like.

In an example, a difference between the thickness size d1 of the upper portion 11a or the lower portion 11b and the thickness size d2 of the middle portion 11c ranges from 0.3 mm to 1.8 mm, or 0.3 mm to 1.5 mm, or 0.3 mm to 1.2 mm, or 0.3 mm to 1 mm, or 0.3 mm to 0.8 mm, or 0.5 mm to 0.8 mm.

A conductive element includes a conductive electrode 13 and a conductive electrode 14 that are spaced apart from each other and arranged on the base body 11. Being spaced apart from each other means that no direct contact exists between any two electrodes to form a short circuit.

A continuous conductive coating is preferably used as the conductive electrode 13 and the conductive electrode 14. The conductive coating may be a metal coating. The metal coating may include silver, gold, palladium, platinum, copper, nickel, molybdenum, tungsten, niobium, or the foregoing metal alloy materials. A thickness of the metal coating ranges from 0.05 μm to 50 μm, or 0.1 μm to 50 μm, or 0.5 μm to 50 μm, or 1 μm to 50 μm, or 5 μm to 50 μm, or 5 μm to 40 μm, or 5 μm to 20 μm, or 5 μm to 10 μm. The metal coating of such a thickness helps reduce contact resistance.

The conductive electrode 13 is arranged on an end surface of the proximal end of the base body 11. The conductive electrode 13 is arranged on an entire end surface of the proximal end of the base body 11, thereby forming a planar electrode in a shape of a circular ring. The planar electrode is perpendicular to an axis of the base body 11. A thickness size of the conductive electrode 13 is the same as the thickness size of the upper portion 11a. Certainly, it is also feasible that the conductive electrode 13 is arranged on a portion of the end surface of the proximal end of the base body 11. For example, a planar electrode in the shape of a ring with a notch is formed. The conductive electrode 14 is arranged on an end surface of a distal end of a base body 11, and is otherwise similar to the conductive electrode 13. The conductive electrode 13 and the conductive electrode 14 are arranged on the end surfaces of the base body 11. On the one hand, a side wall space of the base body 11 is not occupied to facilitate a reduction in heat capacity of the base body 11, thereby improving the heating efficiency of the heater. On the other hand, an electrical connection with the battery core 30 is facilitated.

After the heater 10 is energized, for example, the conductive electrode 13 is electrically connected to a positive electrode of the battery core 30, and the conductive electrode 14 is electrically connected to a negative electrode of the battery core 30, a current flows from the proximal end of the base body 11 to the distal end of the base body 11 along an axial direction of the base body 11.

The first electrode connector 63 is maintained in contact with the conductive electrode 13 of the heater 10, thereby forming an electrical connection. The first electrode connector 63 facilitates the electrical connection with the battery core 30. For example, a wire electrically connected to the battery core 30 is welded to the first electrode connector 63. The second electrode connector 65 is arranged in a similar manner.

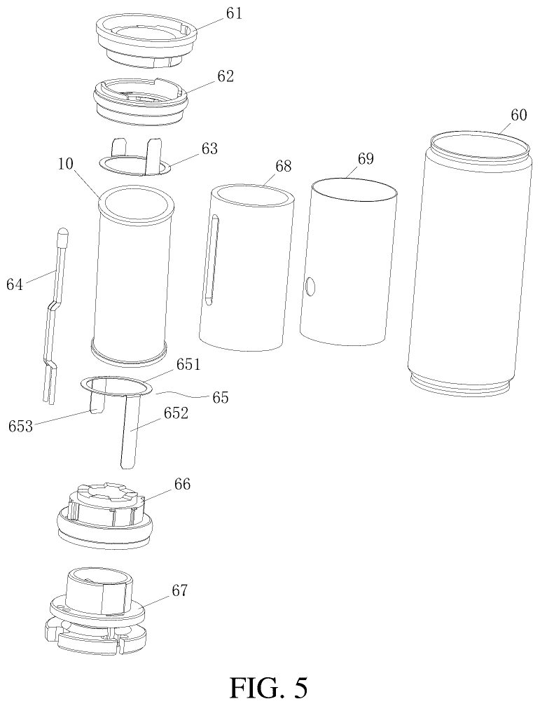

The first electrode connector 63 and the second electrode connector 65 have substantially the same structure. The second electrode connector 65 in FIG. 5 is used as an example for description below. For the first electrode connector 63, reference may be made to the description.

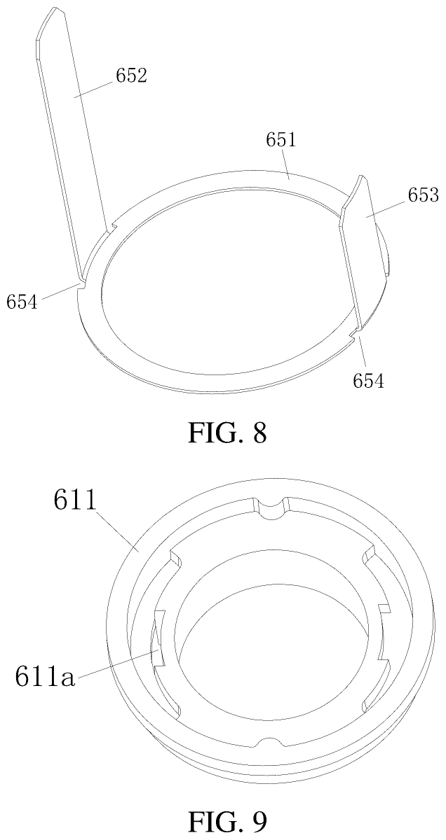

As shown in FIG. 8, the second electrode connector 65 is preferably made of a copper alloy material, for example, beryllium copper, titanium copper, or phosphor copper. A surface may be plated with gold, silver, or the like to reduce contact resistance and increase a service life of the second electrode connector 65. A pure silver material may also be used.

The second electrode connector 65 includes an annular body 651 and a pin 652.

The annular body 651, for example, maintains contact with the conductive electrode, thereby forming an electrical connection. An outer diameter of the annular body 651 is the same as an outer diameter of a lower portion 11b, or slightly greater than the outer diameter of the lower portion 11b. An inner diameter of the annular body 651 is slightly less than the inner diameter of the base body 11. For example, a difference between the two inner diameters ranges from 0.1 mm to 0.3 mm, to ensure smooth insertion of an aerosol generating article 200. One side of the annular body 651 is in contact with an end surface electrode (a conductive electrode 14) of the base body 11, and an other side is in contact with a first seal member 62. The annular body 651 is maintained in contact with the end surface electrode through an elastic force of the first seal member 62, thereby ensuring a reliable electrical connection.

The pin 652 extends from the annular body 651 toward the lower end cap 67 or in a direction away from the base body 11. A wire electrically connected to the battery core 30 may be soldered to the pin 652.

In a further implementation, the second electrode connector 65 further includes a positioning portion 653. The positioning portion 653 also extends from the annular body 651 toward the lower end cap 67 or in the direction away from the base body 11. The positioning portion 653 facilitates assembly and positioning. Further, the positioning portion 653 may be provided with a boss or a barb to ensure reliable positioning, a smooth mounting process, and not easy to fall out.

In a further implementation, the second electrode connector 65 further includes a crack-stopping groove 654. The crack-stopping groove 654 may prevent tearing or distortion when the pin 652 or the positioning portion 653 is formed.

The temperature sensor 64 is configured to sense temperature information of the heater 10.

An upper end cap 61 is arranged on the proximal end of the base body 11 to keep the proximal end of the base body 11; and a lower end cap 67 is arranged on the distal end of the base body 11 to keep the distal end of the base body 11. The upper end cap 61 and the lower end cap 67 are made of insulating, high-temperature resistant and heat insulating materials, for example, PEEK, PI, PBI, PPS, and temperature resistant PC.

The first seal member 62 and a second seal member 66 are made of a flexible material, preferably a high-temperature resistant silica gel material, or may be fluororubber or another high-temperature resistant elastic material, to ensure stable operation and a long service life of the material in a high-temperature environment. The first seal member 62 is arranged between the upper end cap 61 and the proximal end of the heater 10. The second seal member 66 is arranged between the lower end cap 67 and the distal end of the heater 10. A gap between the heater 10 and an end cap is sealed through the first seal member 62 and the second seal member 66.

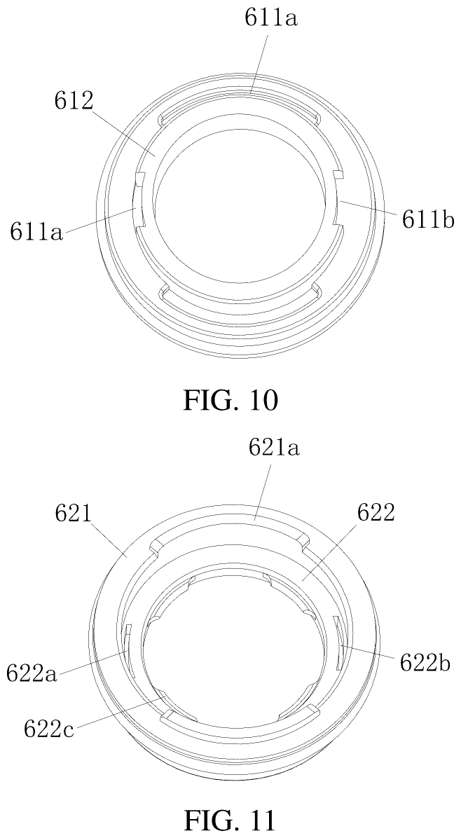

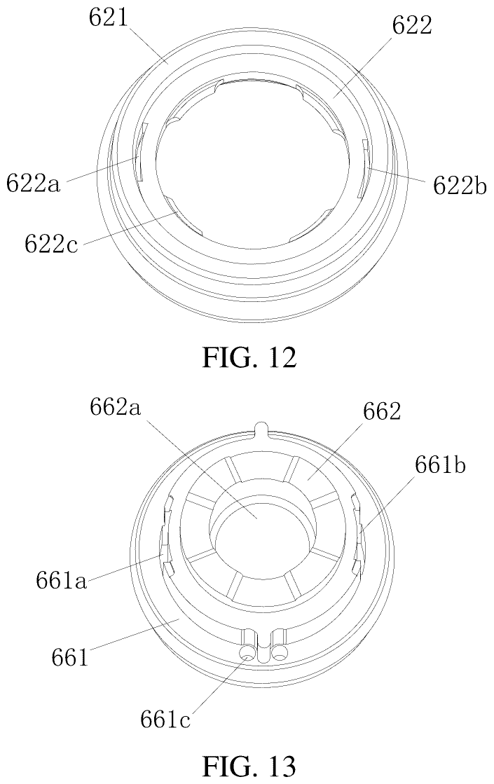

For understanding with reference to FIG. 9 to FIG. 12, the upper end cap 61 and the first seal member 62 are substantially in a tubular structure.

The upper end cap 61 includes an upper portion 611 and a lower portion 612 that are axially distributed. A lower end surface of the upper portion 611 is provided with a groove 611a. A lower portion 612 protrudes from the lower end surface of the upper portion 611 toward the first seal member 62. An outer diameter of the lower portion 612 is less than an outer diameter of the upper portion 611. The lower portion 612 is provided with a through hole 611a. The through hole 611a extends through the upper portion 611 and the lower portion 612. An outer side wall of the lower portion 612 is further provided with a groove 611b.

The first seal member 62 includes a peripheral portion 621 and an inner portion 622 that are radially distributed. An upper end surface of the peripheral portion 621 is provided with a protruding post 621a corresponding to the groove 611a. The inner portion 622 extends radially from an inner wall of the peripheral portion 621. An axial size of the inner portion 622 is less than an axial size of the peripheral portion 621. The inner portion 622 is provided with a through hole 622a and a through hole 622b. The through hole 622a and the through hole 622b extend through upper and lower ends of the inner portion 622. An inner wall of the inner portion 622 is further provided with a plurality of convex ribs 622c at intervals. The convex ribs 622c facilitate clamping of the aerosol generating article 200. External gas can also flow into a chamber 10 from a gap between adjacent convex ribs 622c.

During assembly, the lower portion 612 of the upper end cap 61 is received in the peripheral portion 621 of the first seal member 62, the lower end surface of the lower portion 612 of the upper end cap 61 abuts against the upper end surface of the inner portion 622 of the first seal member 62, and the convex post 621a is connected to the groove 611a. The upper portion 11a of the base body 11 may be received in the peripheral portion 621 of the first seal member 62, and the lower end surface of the inner portion 622 of the first seal member 62 keeps the annular body of the first electrode connector 63 in contact with the end surface electrode, thereby ensuring reliable electrical connection. Pins of the first electrode connector 63 extend out of the upper end cap 61 through the through holes 622a and 611a, and a positioning portion of the first electrode connector 63 passes through the through hole 622b and is kept in the groove 611b.

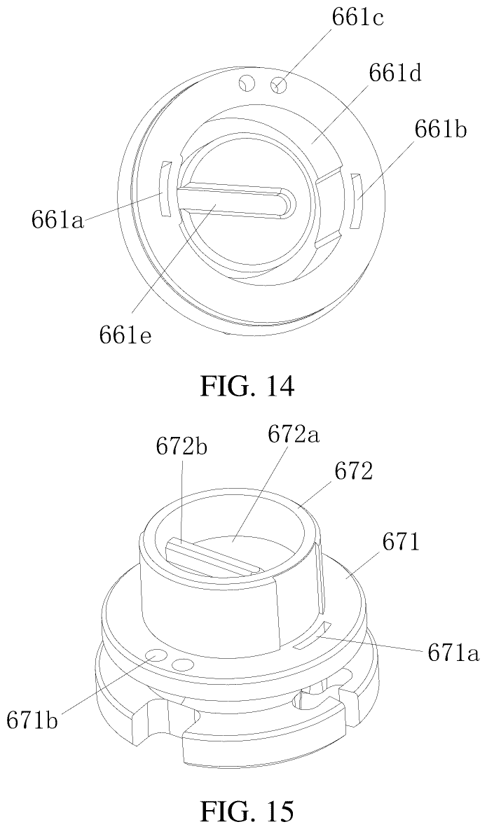

For understanding with reference to FIG. 13 and FIG. 14, the second seal member 66 includes a body 661 and a protruding portion 662 that are axially distributed.

The body 661 is substantially in a shape of a tube, where an upper end of the body is a closed end, and a lower end of the body is an open end. The body 661 is provided with a through hole 661a, a through hole 661b, and a through hole 661c.

The protruding portion 662 is substantially in the shape of a tube. The protruding portion 662 extends from a partially closed end of the body 661 toward the proximal end of the base body 11. A hollow portion inside the protruding portion 662 forms a chamber 662a.

During assembly, a portion of the protruding portion 662 extends into the heater 10 to form a support portion. When an aerosol-forming article 200 is received within the heater 10, the support portion may support the aerosol-forming article 200. A bottom end of the aerosol-forming article 200 received within the heater 10 may close the chamber 662a. On the one hand, the chamber 662a may store a certain amount of air. When a negative pressure is formed through inhalation, the stored air may be replenished into the aerosol-forming article 200 in a timely manner, which helps increase a concentration of an aerosol and then enhances inhalation experience of the user. External air flows through a gap between the bottom end of the aerosol-forming article 200 and the support portion and is replenished into the chamber 662a. On the other hand, the chamber 662a may collect condensate and residues to facilitate cleaning.

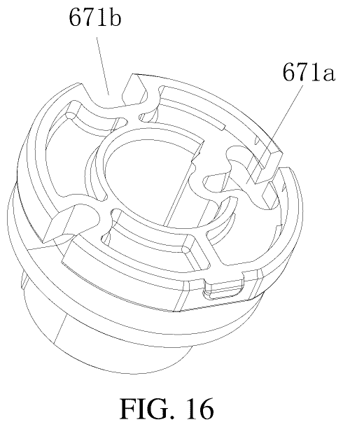

For understanding with reference to FIG. 15 and FIG. 16, similar to the second seal member 66, a lower end cap 67 includes a body 671 and a protruding portion 672 that are axially distributed.

The body 671 is substantially in a shape of a tube, where an upper end of the body is a closed end, and a lower end of the body is an open end. The body 671 is provided with a through hole 671a and a through hole 671b.

The protruding portion 672 is substantially in the shape of a tube. The protruding portion 672 extends from a partially closed end of the body 671 toward the proximal end of the base body 11. A hollow portion inside the protruding portion 672 forms a chamber 672a.

During assembly, the protruding portion 672 of the lower end cap 67 extends into a hollow portion 661d inside the body 661 of the second seal member 66. In a further implementation, the chamber 672a is provided with a bump 672b. The hollow portion 661d is provided with a groove 661e corresponding to the bump 672b. Through cooperation of the bump 672b and the groove 661e, the connection between the lower end cap 67 and the second seal member 66 can be achieved.

An upper end surface of the body 661 of the second seal member 66 keeps the annular body 651 of the second electrode connector 65 in contact with an end surface electrode, thereby ensuring reliable electrical connection. A pin 652 of the second electrode connector 65 extends to outside of the lower end cap 67 through a through hole 661a and a through hole 671a. A positioning portion 653 of the second electrode connector 65 is kept in the through hole 661b. A wire connected to a temperature sensor 64 may extend to outside of the lower end cap 67 through the through hole 661c and the through hole 671b.

A heat insulation member 68, a keeping member 69, and an insulator 60 are sleeved on the heater 10 in sequence along a radial direction of a chamber 20. The heat insulation member 68 includes aerogel. The aerogel may cover an entire outer side wall of the base body 11, thereby improving a heat insulation effect of a heating assembly, and helping to improve heating efficiency of the heating assembly. The keeping member 69 is made of a PI material, and is configured to keep the heat insulation member 68 and the temperature sensor 64 on the heater 10. The insulator 60 has a double-layer tube arranged in the radial direction of the chamber, and the double-layer tube may be sealed and filled with gas or evacuated. An upper end of the insulator 60 abuts against the upper end cap 61, and a lower end of the insulator 60 abuts against the lower end cap 67.

It should be noted that the specification of this application and the accompanying drawings thereof illustrate preferred embodiments of this application. However, this application may be implemented in various different forms, and is not limited to the embodiments described in this specification. These embodiments are not intended to be an additional limitation on the content of this application, and are provided for the purpose of providing a more thorough and comprehensive understanding of the content disclosed in this application. In addition, the foregoing technical features are further combined with each other to form various embodiments not listed above, which are all deemed to be within the scope of the description of this application. Further, a person of ordinary skill in the art may make improvements or modifications according to the above descriptions, and all of the improvements and modifications shall fall within the protection scope of the appended claims of this application.

1. A heater, comprising:
a base body, having a proximal end and a distal end opposite to each other, wherein a material of the base body comprises a conductive ceramic, and the base body is configured to heat an aerosol-forming substrate to generate an aerosol;
the base body comprises a first portion close to the proximal end or the distal end, and a second portion located between the proximal end and the distal end, and a thickness size of the first portion is greater than a thickness size of the second portion; and
a conductive electrode, arranged on an end surface of the proximal end and/or the distal end.

2. The heater according to claim 1, wherein the base body is configured to generate an infrared ray for radiative heating of the aerosol-forming substrate.

3. The heater according to claim 1, wherein the base body is configured to perform heating around at least one portion of the aerosol-forming substrate.

4. The heater according to claim 1, wherein the thickness size of the second portion ranges from 0.5 mm to 0.2 mm.

5. The heater according to claim 1, wherein the base body is configured as a tubular structure, and an inner diameter of the base body ranges from 6 mm to 15 mm or ranges from 5 mm to 5.9 mm.

6. The heater according to claim 1, wherein the conductive electrode is arranged on an entire end surface of the proximal end and/or the distal end.

7. The heater according to claim 6, wherein the base body is configured as a tubular structure, and the conductive electrode is configured as a planar electrode in a circular ring shape.

8. The heater according to claim 1, wherein a difference between the thickness size of the first portion and the thickness size of the second portion ranges from 0.3 mm to 1.8 mm.

9. The heater according to claim 1, wherein a thickness of the conductive electrode ranges from 0.05 μm to 50 μm.

10. An aerosol generating device, comprising:
a housing;
the heater according to claim 1, wherein the heater is arranged in the housing; and
a battery core, configured to provide electric power.

11. The aerosol generating device according to claim 10, further comprising an electrode connector, wherein the electrode connector comprises a body that keeps in contact with a conductive electrode, and a pin extending from the body toward a direction away from the base body.

12. The aerosol generating device according to claim 11, wherein the electrode connector further comprises a positioning portion extending from the body toward the direction away from the base body.
